(19) United States
(12) Patent Application Publication
(10) Pub. No.: US 2011/0155044 A1
(43) Pub. Date: Jun. 30, 2011

(54) KINESTHETICALLY CONCORDANT OPTICAL, HAPTIC IMAGE SENSING DEVICE

(76) Inventors: David Burch, Powhatan, VA (US); Dianne Pawluk, Richmond, VA (US)

(21) Appl. No.: 12/809,224

(22) PCT Filed: Dec. 19, 2008
(86) PCT No.: PCT/US08/87605

§ 371 Date: Mar. 10, 2011

Related U.S. Application Data
(60) Provisional application No. 61/015,752, filed on Dec. 21, 2007.

(51) Int. Cl. G01D 21/00

(52) U.S. Cl. 116/205

(57) ABSTRACT

A haptic system which utilizes a combination of tactile and kinesthetic sensing allows a visually impaired person to sense visual and graphical information, such as graphs, figures, and images, on computer displays or printed material. An optical sensor is positioned on a person's hand, e.g., on the person's finger or fingers, or on the person's palm, or is positioned on a stylus used by the person. The optical sensor is traced over an image. When the sensor passes over or follows a location of color or an edge or point of contrast of the graphical information or image, e.g., a line graph, bar graph or pie chart, tactile feedback is provided to the user. The combination of the mechanical stimulation in the same area of the hand used in the sensing (i.e., being kinesthetic ally concordant) will allow the user to more easily and quickly ‘sense’ the shape or image presented on the display or paper.

This invention was made with support in part from a grant from the National Science Foundation (NSF HS grant 0712936), and the U.S. Government may have certain rights in the invention.

### FIELD OF THE INVENTION

The invention is generally related to mechanisms which enable visually impaired individuals to sense graphical images using haptic feedback.

### BACKGROUND

For individuals with sight, graphical visual representations are a universal means for conveying unfamiliar information. Their use ranges from teaching young children some of their first words, to guiding tourists without concern for language barriers, to helping visualize complex data. However, for individuals who are visually impaired, there are few appropriate tools available to obtain access to this same information. One technique used is to replace a graphic using words in text or auditory form. However, there are many situations for which words, either in text form or speech, are simply inadequate. Moreover, words cannot be used in situations where language barriers exist, regardless of form.

Displaying time-series data and its analyses in a graph to look for spatial patterns is a fundamental way of enhancing insight into a scientific experiment or financial situation. Determining spatial relationships can also be particularly important for understanding how machinery and devices should be used in the workplace, as well as the spatial layout of a person's work environment. Having access to all these types of information would allow a person who is visually impaired to perform more tasks independently, improving both their self-esteem and value in the workplace. Furthermore, providing graphical information to young children or children that have not learned a language permits them to discover patterns and spatial relationships, which is essential for the educational development.

The most common haptic method of representing an image is by the use of a static raised-line drawing. These drawings are prepared by a sighted person and essentially comprise of an outline of an image wherein the lines are permanently elevated above the background on a piece of paper. This technique is expensive as it requires preparation of a specialized drawing. Further, this technique does not provide access to information on paper medium where a specialized drawing is not available and provides no access to information that would be displayed on a computer screen or other display. Finally, this technique does not provide color information or other information about contrasts in hue or color density within the image.

Kees van den Doel, “SoundView: Sensing Color Images by Kineshetic Audio”, Procedings of the 2003 International on Auditory Displays, Boston, Mass., 2003 describes translating image colors to an associated “roughness” encoded by varying scraping sounds. Specifically, Kees van den Doel shows encoding color characteristics such as hue, saturation and brightness by altering the digital filter characteristics for the scraping sound output. However, the use of non-speech auditory feedback as a substitute for visual feedback can interfere with speech recognition due to masking effects. Such auditory masking can inhibit learning during classroom instruction where normally visual and auditory information are present simultaneously. In addition, hearing has no correlate to using multiple fingers, a potential method to speed up the very slow, serial processing of information that occurs with audition.

U.S. Pat. No. 5,736,978 to Hasser describes a tactile graphics display which purportedly enhances communication of graphic data to a sight impaired person. The Hasser device employs a mouse, a digitizer pad, and a tactile feedback array, and operates in conjunction with a computer. As the user moves the mouse on the digitizer pad, and the cursor moves past geometric objects on the display, the user is provided with tactile feedback on the array. The Hasser device provides a number of advantages to the sight impaired; however, the device only operates with computerized information (not printed material), and dissociates the person's hand from the shapes through the use of the mouse, i.e., there is no kinesthetic concordance with the tactile feedback. Further, Hasser does not account for different colors, hues and densities in an image.

U.S. Pat. No. 6,424,333 to Tremblay describes a tactile feedback interface that allows a user to interact with a virtual reality environment. Tremblay shows the use of vibratory devices on a person's fingers and hands, as well as many other parts of the person's body. The interface provides the user with tactile stimulation as the user interacts with the virtual reality environment. Tremblay is a position oriented device and is not related to recognition of images by a sight impaired person.

### SUMMARY

According to the invention, a user is provided with a sense of an image presented on a display or paper medium by having a support associated with the user's hands where an optical sensor and an actuator which provides mechanical stimulus to the user are associated with the support. As the user moves his or her hands over the image, an area of said user's hand or hands (e.g., finger tips, palm) at a point or points that correspond to a location of color within said image or location of contrast in said image are provided with kinesthetically concordant tactile feedback.

A principle of the device is that the user can move the device(s) across a visual representation of a graphic. The device(s) will detect the contrast or color of the image underneath the optical sensor(s), process the detected optical image, and the use an actuating component(s) to provide mechanical stimulation in the same are of the hand used for sensing. In short, when a color or contrast location is detected, the user will be provided with tactile feedback. Because the user is moving his or her hands over the image, the tactile feedback is concordant with kinesthetic feedback. For example, the sensor and actuator may both be located on the same finger, with the actuator vibrating when the optical sensor detects the presence of an edge (or color, or different hue or density of a color, etc.). Movement of the user's hand in space provides kinesthetic information of the location(s) of the sensor/actuator pair in space. This, together with the tactile feedback provided by the actuator will create a haptic “visualization” of the image.

Preferably, the device can be used on any type of medium, e.g., a piece of paper or a computer screen. In the case of using a computer screen, the preferred orientation is to have the screen facing upwards for ergonomic reasons. There is no limit to the size of the medium that can be used. Another advantage of the device is that a sighted person can see the graphic the user is examining, and can see where the user is “looking” on it (i.e., where his or her hand or finger is located).

The device preferably includes an optical sensor, actuator and contact sensor. The optical sensor can be a single photosensor, such as a photointeruptor or photodiode, or a more complex imaging device such as a CCD or CMOS imaging array. A single photosensor is advantageous for minimizing cost, size and complexity of the complete device. The sensor can be used for the basic interpretation of line drawings or when the processing of the graphic into a usable haptic form is to be performed external to the device (e.g., by a computer generating the representation on a screen or printed on paper). An imaging array may be used to permit more complex processing. The actuator component may consist of a vibrating device such as a piezoelectric actuator or a small linear motor. A vibrating device is advantageous for minimizing cost and size of the complete device; however, a linear motor could provide more flexibility in terms of the signal presented to the user. A velocity or position sensing system measuring lateral speed of the device may be included to enable the consistent generation of simulated textures with changing hand speed. Also, a force or pressure sensing system can be included for measuring the normal force between the medium and the device to enable the generation of simulated compliance. In some cases, the optical sensor which is used will not be able to distinguish when the sensor is on the medium being used and when it is in the air. A push button contact detector can be incorporated in back of the optical sensor to shut the actuator off, if the device moves of the medium (e.g., this arrangement might be advantageously employed in a stylus based embodiment of the invention).

The shape of the contact between the optical sensor and the rest of the device should reflect the spatial resolution to be used. In one embodiment, this resolution may be set by the optical sensor or by some external source. This will provide the appropriate haptic cues for accurate spatial localization of the contact point and interpretation of the resolution of the device. It may also be desirable to change the resolution used during active uses of the device. In this case, the shape of the contact could change concurrently to adjust the haptic cues appropriately. This could be done, for example, by using concentric hollow cylinders to indicate the different spatial resolutions used, with the exception of the highest resolution on the inside. The cylinders could be raised and lowered by, for example, a turn-screw actuator or a set of mechanical switches.

Preferably, the electronics and/or control systems needed to drive the sensor, actuator, and part or all of the processing between the two may be incorporated into the device itself and may be mounted on the individual's arm or body, or exist externally. In addition, the electronics for multiple devices used simultaneously used simultaneously (e.g., several finger tip sensor/actuators) may exist separately or be combined into one electronic device.

The form of the device can be either in a shape held by the hand (such as a stylus) or mounted on the fingertips or other part of the hand or wrist. In the case of the stylus or other hand held device, the optical sensor will preferably be at the tip with the actuating component embedded in or attached to the housing portion which is held by the user's fingers. In the case of a device mounted on part of one or more fingers, the optical sensor may be mounted on either the tip or the dorsal side of the finger, with the actuator mounted on any side of the finger (when in the same location as the sensor, the actuator is preferably located closer to the skin). In the case of other positions on the hand or wrist, the optical sensor is preferably mounted on top of the actuator with the actuator being closest to the skin. In the case of a stylus, the housing of the stylus functions as a support for both the optical sensor and the actuator. In the case of a finger, glove, or other hand device, a support will typically be secured to the finger or hand and will support both the optical sensor and the actuator. A glove type support might be used to support either or both a plurality of finger sensors/actuators, and a palmar or wrist sensor/actuator. Preferably, more than one device can be used by one person. For example, ten devices might be mounted on the fingers of both hands to allow the user to use the whole of both hands for sensing, which is more in accordance with what is naturally done with the hands.

### DESCRIPTION OF THE DRAWINGS

FIGS. 1a-1d are a drawing of a palm-held optical element and actuator device in a) an isometric view, b) a bottom view, c) a front view, and d) a top view;

FIGS. 2a shows a top oriented isometric view of finger mounted optical element and actuator with the control circuitry mounted on the top of the figure, 2b shows a side view, 2c shows a bottom oriented isometric view, and 2d shows a mesh isometric view of the same configuration;

FIG. 3 is an alternative finger mounted optical elemental and actuator with control circuitry mounted within the support: a) shows a side view of the configuration, b) shows an isometric view, c) shows a bottom oriented exploded isometric view, and d) shows a top oriented exploded isometric view;

FIG. 4 is an exploded view of a stylus design for the optical element and actuator;

FIG. 5 is a top view of the finger mounted optical element and actuator with the control circuitry or processor mounted on the user's hand;

FIG. 6 is a circuit diagram of an exemplary controller using op-amps for analog DC motor actuation;

FIG. 7 is an alterative circuit diagram of an improved exemplary controller using transistors for digital DC motor actuation;

FIG. 8 is a schematic drawing of an improved actuator and optic assembly for a glove type prototype that uses piezoelectric actuation;

### DETAILED DESCRIPTION

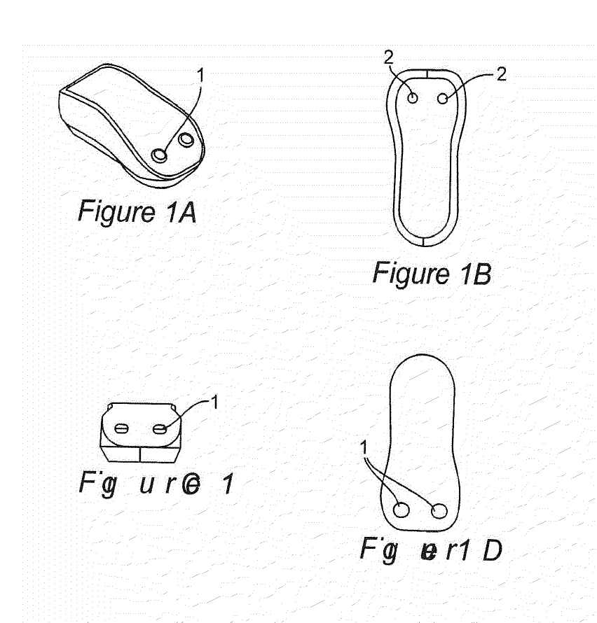

FIGS. 1a-d show an embodiment of the invention where the optical element(s) 2 is positioned on the underside of a palm-held support, and the vibratory actuator(s) is positioned on the topside of the device. In this configuration, the user's finger(s) would rest upon the actuators 1, while the user would move the device over a visual image, enabling the optical sensor(s) 2 to scan the image, detecting elements of varying color or contrast. Upon detection of arbitrary values of color or contrast, the device is set to provide corresponding tactile feedback resulting from mechanical actuation. All controlling circuitry (not shown) would be contained inside the embodiment. The device could have external power supply via a power cord or usb cord (not shown) or internal power supply via a self-contained battery.

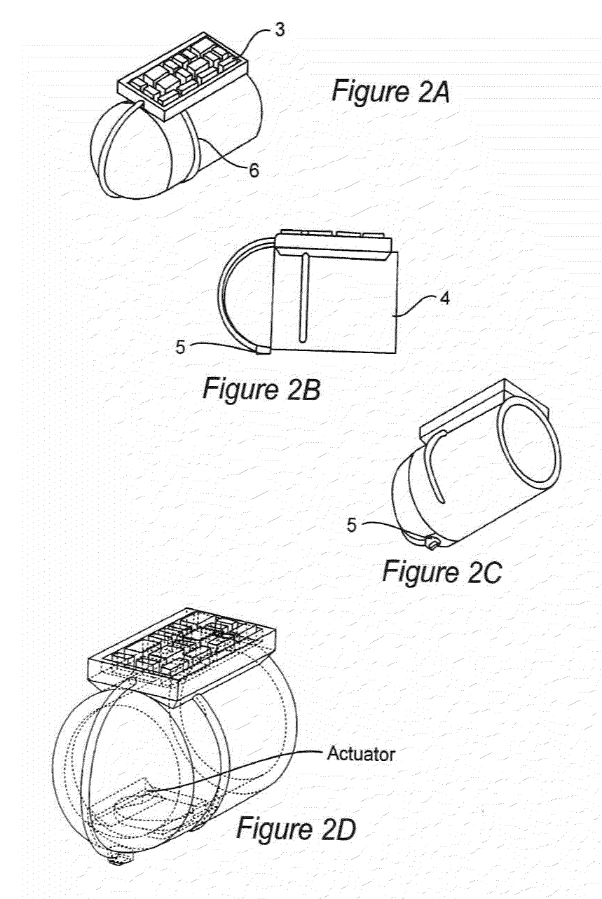

FIG. 2a shows a finger mounted embodiment of the invention where the controlling circuitry 3 is mounted on the ventral side of the finger, which connects to the optical element and actuator through wires 6. FIG. 2b shows the structural element 4, which encloses the user's finger. FIG. 2c shows the optical element 5 mounted on the dorsal side of the finger, affixed to the case 4. FIG. 2d shows the location of the actuator, affixed internally in the case 4, so that the dorsal side of the user's finger rests upon the actuator. This design also has the added convenience that the tactile feedback provided by the vibratory actuator is coupled with the point of contact with the image, which has been shown to provide a more natural mode of haptic exploration. It should be understood that the vibratory actuator, also referred to as the “haptic element”, can also be positioned on rear, side or front of the finger tip (in which case the optic element would be adjacent or on top of the vibratory actuator). This configuration has the convenience that the user does not need to be connected to a computer or other controller when he or she is sensing images on a paper medium or computer display, However, it should be recognized that the controller can be positioned in a computer housing or be separate and apart from the user's hand. Finally, while FIG. 2 collectively show a single finger mounted optical sensor and actuator device, in some embodiments it would be useful to have a plurality of finger mounted optical sensor and actuator devices mounted on each of the user's fingers so that he or she could use all of his or her fingers simultaneously to sense the shape, color, or other information about the image on the display or paper medium. In this embodiment, there may be a separate controller for each finger optical sensor and actuator device or there may be a single controller for all of the finger optical sensor and actuator devices on one or both hands.

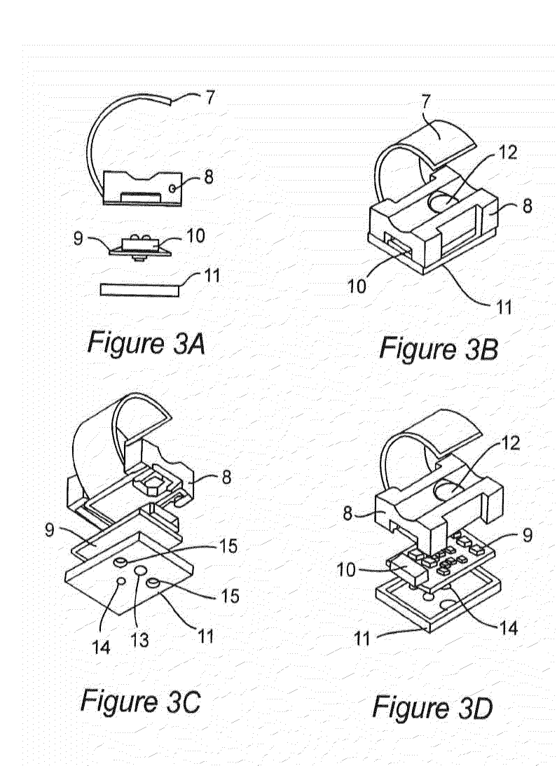

FIGS. 3a-d show an alternative finger mount design for the invention where the device straps on to the user's finger using either an elastic band or Velcro strap 7. FIG. 3a shows how the design consists of three layers; a) a bottom layer 11, which supports the circuitry 9, and has multiple openings: a hole for the optical element 14, an opening for the push-button switch to stick through 13, and two screw holes 15 to affix the bottom layer 11 to the top layer 8 (shown in FIG. 3c); b) a printed-circuit board (PCB) 9 containing the optical element, push-button switch, connector for wires or a wireless device 10, and control circuitry (shown in FIG. 3d); and c) a top layer 8 containing a piezoelectric actuator 12 that affixes to the bottom layer 11 using screws 15 (shown in FIGS. 3b and 3d). This configuration has the convenience that the design can easily adjust for a variety of finger sizes, unlike the case 4 shown in FIGS. 2a-d, and that straps of different sizes can be easily swapped out if necessary. It should be noted that this design also possesses features similar to those exhibited by the device shown in FIGS. 2a-d, namely, that it can be used in conjunction with a plurality of devices mounted on multiple fingers, with or without the use of a computer.

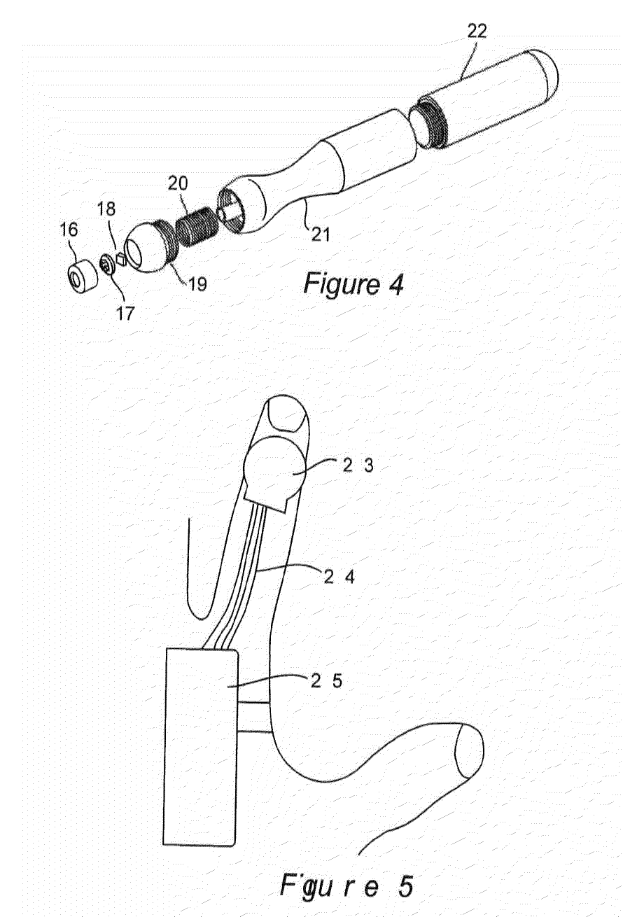

FIG. 4 shows a stylus embodiment of the invention. The stylus is basically any tool which can be held in a person's hand which can be moved over a display or printed medium. The stylus may include a push button contact sensor 16 biased by a spring 20 or other biasing member. The stylus would contact the display or paper medium (not shown), and would sense contact by the contact sensor 16. If the stylus left the display screen or paper medium, the contact sensor 16 could provide a signal to the controller which would turn off the optical sensing system or vibratory system. The optical sensing system may include a small lens 17 and photointerrupter 18 located at the tip of the stylus. The vibratory system could include a motor or other vibratory device positioned in a hard plastic housing 21 and 22. Similar to the system discussed above in conjunction with FIG. 1, the optical system would detect colors or contrasts, and the presence of colors (or specific hues or densities) and contrasts would lead the vibratory system to cause the hard plastic housing 21 to provide mechanical stimulus from which the user could discern the color or contrast in the image displayed on a display or printed on a paper medium. The plastic housing 22 could also include a battery, control circuitry or computer, an antenna or transceiver, or other components.

FIG. 5 shows a vibratory actuator 23 on the ventral side of a person's finger. It should be understood that the vibratory actuator 23, also referred to as the “haptic element”, can be positioned on ventral, side or dorsal part of the finger tip (in which case the optic element would be adjacent or on top of the vibratory actuator). The wires 24 are preferably connected to a hand mounted control box 25 which controls the vibratory actuator 23 based on signals from the optical element. This configuration has the convenience that the user does not need to be connected to a computer or other controller when he or she is sensing images on a paper medium or computer display, However, it should be recognized that the controller can be positioned in a computer housing or be separate and apart from the user's hand. In addition, with reference back to description for FIGS. 2a-d, an antenna connection (e.g., a transceiver) permits the controller to be positioned almost anywhere within transmission radius. Finally, while FIG. 5 shows a single finger mounted optical sensor and actuator device, in some embodiments it would be useful to have a plurality of finger mounted optical sensor and actuator devices mounted on each of the user's fingers so that he or she could use all of his or her fingers simultaneously to sense the shape, color, or other information about the image on the display or paper medium. In this embodiment, there may be a separate controller for each finger optical sensor and actuator device or there may be a single controller for all of the finger optical sensor and actuator devices on one or both hands.

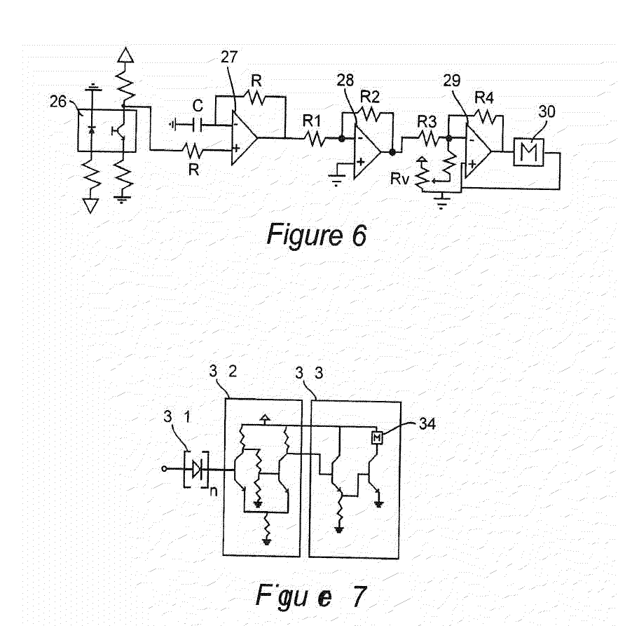

FIG. 6 shows a preliminary circuit design for the invention that utilizes a photointerrupter 26 to provide optical sensing and a low-power motor 30 to provide feedback actuation. The first stage of the circuit 26 shows the diagram for the photointerrupter (encompassed in the box) and the necessary connections to power the element. The second stage of the circuit 27 shows a basic buffer design of utility gain, followed by an amplifier circuit 28 to increase the signal strength. The final stage of the circuit 29 removes any DC offset in the signal and provides further signal amplification. It should be understood that this circuit shows the principle that the signal must be buffered and amplified, and that any DC offset must be removed in order to directly drive a motor using the analog signal, but that this is not representative of the only configuration to accomplish that goal.

FIG. 7 shows an alternative circuit design that uses the output of a photosensor such as the photointerrupter 26 in FIG. 6, to drive a motor with greater power requirements which would prohibit the use of a circuit similar in operation to the one in FIG. 6. The diodes 31 shown in FIG. 7 represent a means to remove any DC offset voltage using a cheaper, passive component alternative to the operational amplifier 29 shown in FIG. 6. The Schmidt trigger 32 negates the issue of signal amplification by digitizing the signal into a binary output consisting of either a high (or ‘on’) signal, or a low (or ‘off’) signal. The hysteresis for the Schmidt trigger 32 can be set so that the device triggers for events of finer resolution that the analog signal typically would trigger the vibratory feedback 34 for. It should be understood that while the signal from the sensor is only coded to a 1-bit signal, a multi-bit signal could be generated using multiple comparators. In turn, the multi-bit signal could be used to encode multiple output signals, using a design logic design circuit (not shown) or a microcontroller (not shown). The final part of this circuit 33 is a Darlington pair power transistor design to amplify the current allowed for the actuator 34 for devices that have greater current requirements, such as those using pager motors.

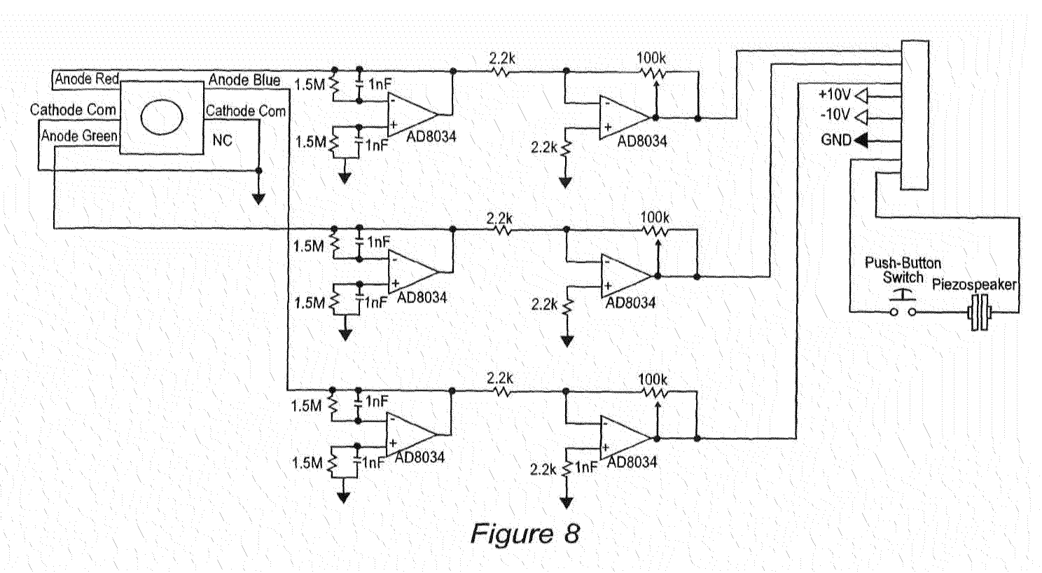

FIG. 8 shows a circuit design for the control of a device which utilizes a multi-channel color (Red, Green, and Blue) diode and a piezoelectric element. The circuit possesses buffering elements for each of the three color channels followed by an amplification element. It should be noted that this design incorporates the use of a computer (not shown) or additional hardware (not shown) to coordinate the channel input with corresponding tactile feedback in real-time. The signal that outputs from the computer or additional hardware that drives the actuator is interrupted by a push-button switch, causing the device to only operate when it is pressed against a medium such as a printed graphic or a video screen or monitor. It should be understood that this placing for the push-button switch is not the only possible location, as it can also interrupt the power supply line. This circuitry shown in FIG. 8 is a diagram for the circuitry on the PCB 9 in FIG. 3d. If additional current is necessary to drive the actuator, a Darlington pair power transistor similar to the one shown in 33 of FIG. 7 can be implemented to increase the current allowed to the actuator.

This invention is designed to enable individuals who are blind or otherwise visually impaired to sense visual images using their haptic sense. There are many design constraints for this invention; some are either intrinsic to the body (specifically human perception) and some constraints are extrinsic to the body (i.e., accessibility). Attention to these constraints defines the invention and separates it from similar devices. The intrinsic constraints are based upon the characteristics of human perception and safety concerns. The extrinsic constraints directly addressed are device affordability, portability, and multi-application use.

The intrinsic characteristics of human perception limit the use of certain senses to render visual information. Taste and olfaction (smell) are not suitable means to convey visual information, for many reasons, including social considerations and the potential for sanitary concerns. This leaves the use of auditory feedback and haptic feedback. The use of auditory feedback has few limitations that separate it from the use haptic feedback, save one: no aspect of auditory feedback can be processed in parallel (unlike haptic feedback), limiting the processing of the feedback to serial exploration, which is slower and places a greater cognitive demand on the user. Thus, the use of haptic feedback by the invention signifies an important distinction between it and similar devices that use auditory feedback.

Haptic sensing consists of two separate sensory systems (tactile and kinesthetic sensing) that become integrated in the brain to convey information about an object's geometric shape and surface composition without needing sight. Tactile sensing is composed of four mechanoreceptors in the skin that sense 1) indentation or pressure, 2) skin stretch, 3) low-frequency vibration/indentation, and 4) high frequency vibration, as well as receptors for pain, thermal properties (hot or cold), and free nerve endings. Kinesthetic sensing is composed of muscle and joint mechanoreceptors that sense 1) joint position and 2) appendage velocity; this sensory input helps the body coordinate movements and remember object position within a workspace around the body. Typically, the tactile system as a minimal spatial resolution of 1 mm, but in hyperacuity tasks this resolution can be as low as 0.2 mm. The spatial resolution depends largely on the mechanoreceptors simulated by the device, which in turn is dependent on the amplitude of the skin displacement by the feedback, and the frequency of the feedback. Depending on this attributes, the spatial resolution can increase to several millimeters (3-5 mm) to an individual finger, to even the entire hand.

Tactile sensing can occur either in parallel or in serial across the system, depending on the type of stimulus. Studies have shown that surface material properties, such as gross geometric shape, thermal properties, hardness, and surface texture, can be processed early on and simultaneously across a plurality of fingers. However, geometric details that require contour following (a common technique for exploring raised-line images) is processed serially using primarily kinesthetic sensing. Therefore, the addition of multiple fingers in such tasks does not help. Parallel processing allows more information to be integrated faster than serial processing, which for tactile experience pictures and for TexyForm increases the accuracy of object identification. Thus, allowing for parallel processing is one of the features for the invention. To allow for parallel processing, visual information must be rendered using a method that simulates one of the material characteristics that naturally gets processed in parallel; namely, either gross geometric shape, thermally, object hardness (resistance to deformation), and surface texture. Gross geometric shape and thermal properties do not convey enough information to satisfy the need, and outputting a variety of material hardness can be difficult; therefore, surface texture remains the most (and possibly only) viable choice. Thus, using “simulated textures” to render visual information is a second criterion for the invention.

People perceive textures through three dimensions: roughness/smoothness, hardness/softness, and stickiness/slipperiness. As mentioned before, hardness and softness is a difficult dimension to simulate. Additionally, stickiness and slipperiness is currently an ill-defined dimensioned with a poorly-understood contribution to the perception of textures. This leaves roughness and smoothness of textures as the only usable dimension for simulating textures. The roughness of an object depends on user interaction with the surface (force applied by the user and the speed of their hands over the object) and the surface constitution. Surface constitution is used to describe the surface “deviations” or grooves that contribute to the perception of roughness. Surface grooves can vary in terms of the spacing between the beginning of one groove to the beginning of the next, called the spatial period, and the gap separation between two grooves (sometimes expressed as % of the total spatial period, which is referred to as the duty cycle). Studies indicate that grooves with spatial periods below 0.2 mm are perceived through vibration sensing, whereas grooves with greater spatial periods are sensed primarily through skin deformation/pressure, although vibration still plays a minor role. If someone wanted to use texture to render visual information, they could produce textures using spatially generated patterns (like vertical lines, diagonal lines, criss-crossed lines, et cetera) using pin arrays, they could use vibrotactile feedback, or they could try and combine both. Typically, using both methods to create texture patterns presents a problem since the mechanoreceptors sensitive to spatially encoded textures have a much finer resolution than the mechanoreceptors sensitive to temporally encoded (vibration) textures. This was one of the problems with the Optacon, which used a pin array vibrating at 230 Hz to convey spatially distributed information (though, they weren't trying to create textures). By using that method, much of the spatial information presented by the Optacon is lost due to the lack of spatial sensitivity for the receptors sensitive to vibration. Using only vibrotactile feedback is a very simple and affordable way to simulate a wide range of textures for the invented device.

Vibration sensing is somewhat analogous to auditory sensing, in that people can sense differences in pitch (frequency), volume (amplitude), and timbre (waveform shape). There are two main discriminations in vibrotactile sensing, the PC channel and the non-PC channels (NPI-III), with the latter being broken into three separate channels. Each channel is sensitive to its own particular range of frequencies and has its own particular receptive field sizes (that is, the area of skin that a single sensory neuron corresponds to). The overall frequency range of sensing is roughly 3 Hz to 500 Hz. The PC channel is sensitive to frequencies from ˜40 Hz to 500 Hz (peak is between 200 and 300 Hz), and the NPI channel is sensitive to frequencies from 3 Hz to 100 Hz (peak is between 15-35 Hz), so there is overlapping sensitivity. The PC channels are more sensitive to displacement than any of the NP channels, and are sensitive to skin displacements as low as several micrometers (0.002 mm). Studies have shown that varying amplitude affects the perception of frequency, and vice-versa, so since frequency can be varied more than amplitude, amplitude variation was not considered to be an option for the device. Both the PC channel and most of the NP channels have a U-shaped threshold curve, which means they are less sensitive to the extremes of their ranges than they are for the central frequencies. This is particularly notable with the PC channel. In addition, the PC channel also experiences a phenomenon known as adaptation, which is when the receptors become less sensitive to the vibration over time. This occurs quicker (or more frequently) in the bands of peak sensitivity for each of the channels.

Vibrotactile waveforms can be modified in shape usually through one of two methods: 1) modulation or 2) additive synthesis. Modulation is either amplitude modulation or frequency modulation and is identical (though applied differently) to the process for sending out radiowave signals. Amplitude modulation involves simply multiplying two signals together: one signal is called the carrier signal and the other is called the modulator. Additive synthesis is simply adding two or more waveforms of different harmonics (multiples of the fundamental or “base” frequency) to generate a uniform wave, such a triangle wave. Studies have shown that variation in both of these methods can be used to generate perceptually different vibrotactile patterns; however, for amplitude modulated signals there are two important features to note: signals are better perceived when the modulator differs greatly from the carrier (i.e. a high carrier frequency and a low modulator are a good combination), versus lower perception when they are similar. Also, perception is less when the carrier signal lies within the overlapping band between the PC and NPI channel (100 Hz performed worse than 50 or 250 Hz carriers). This all translates to following: vibrotactile signals can effectively vary in 1) frequency between the ranges of (possibly, not tested yet) 10-80 Hz, 120-190 Hz, and 310-500 Hz, 2) they can vary in modulation (with low frequency modulators between 10-35 Hz being best), and 3) they can vary in shape (triangle-, square-, sawtooth-, and sine-waves).

Finally, the invention is safe, and brings no harm to its user. HAVS, or human-arm vibration syndrome, is the primary concern when using vibrotactile feedback for the invention. Several ISO standards have been issued concerning the malady, and address the issue using a frequency-dependent approach of measuring the amplitude of the vibrations. However, many tests show that these standards are inadequate, and that high frequency vibration is more likely to cause localized damage than previously thought.

The extrinsic characteristics are those that are not determined by physiological or psychophysical characteristics, but rather other characteristics external to the user such as socioeconomic concerns, device complexity, portability, and various other issues that are often not part of the initial design process (such as device aesthetics). Affordability is a huge concern, as nearly half of the individuals of employment age who are blind are also unemployed, and the 2002 mean annual income of those who were employed is only $16000. A target cost for the invention was set to <$100, so that the end product could remain relatively affordable. Portability is also seen as an issue, as the invented device should be something that can be easily transported from home to work by even a child without difficulty. Device complexity encompasses both the internal complexity of the parts and how easy they are to fix or replace if broken, and how complex is the total device in terms of its use. Obviously, the answer to both those questions is as easy as possible. Another key issue is with the ability of the invention to render multiple images in a timely fashion. One of the huge problems with raised-line drawings is this that once made, the image is static forever. It never changes, and if a new image is needed, another drawing must be made. However, a dynamic device can render any number of images as long as it has power, allowing the user to control which image to view and greatly increasing the usability in terms of cost and time efficiency. Thus, the invention is capable of dynamic rendering, giving it a huge advantage over the standard means to produce tactile graphics.

Two possible solutions to generate textures are using single-point contact actuation or distributed contact actuation. Single-point contact actuation refers to having the device feedback “transmitted” or actuated onto the user through an individual contact point, typically on the user's hand. Distributed contact actuation refers to having a “display” of multiple contact points (like a pin array on a Braille cell) that are distributed over the skin. Single-point contact devices have the advantage of being typically less-costly than distributed contact devices, because they require less total actuators and the per-actuator cost is typically less. However, this is not the case for the PHANToM device, which provides a single point of force-feedback for the user; this device can cost over $30,000 for a single-unit. Distributed contact devices have the possible advantage of being better at rendering visual information. One study has shown that a 4 or 9 element display is more successful than using point contact display across 5 fingers, but they were not simulating textures in this study. For reasons of cost, a single-point contact display was chosen.

Several different actuators can be used to produce vibrotactile feedback. Motors, voice-coils, piezoelectrics, and shakers are all possible choices. Motors are typically the cheapest means; by placing an unbalanced weight at the end of a cylindrical motor, the motor will produce strong vibrations. This was the actuator chosen for the first prototype and unfortunately, it was a poor choice. While at $0.79 per actuator it was the cheapest option, it could not easily produce different vibrotactile outputs and it required far too much power to operator. Further, it caused discomfort in some subjects testing the device and although this discomfort could not be definitively associated with HAVS, it was seen as unacceptable. Since a shaker is very similar to a motor in terms of output strength, power usage, and size, shakers were also rejected after the motors failed. This left voice-coils and piezoelectrics as possibilities. Voice-coils are simply speaker drivers: they consist of a coil of wire wrapped around a magnet. Piezoelectrics are ceramic material that bends when an electrical voltage is applied across the material. The advantages of voice-coils are they generally cheaper than piezoelectrics, but they have the disadvantage of typically being larger than piezoelectrics to produce the same output strength and they require more power to operate. The cost difference between the two can vary a lot, but typically the dollar difference is about $5 to $7 dollars per actuator. The cost difference between the two was seen as less of factor than the size, as the larger voice-coil would be more cumbersome of a device. Therefore, piezoelectrics were chosen as the actuator for the device.

Another alternative method to using the haptic system previously mentioned is using the auditory system to render visual information. This can be accomplished using two means: 1) an audio description of the visual image is provided, or 2) individual parts of the visual image are rendered using non-speech sounds. The first means does not allow users to independently discover new information on their own, which is an important process in learning, and therefore is not an effective option to replace visual graphics. The second means can interfere with information being simultaneously presented using speech, such as classroom instruction or a presentation during a meeting. Furthermore, it is not an accessible option for individuals who are deaf and blind. Therefore, the auditory feedback was not directly considered an option; however, a vibrotactile signal will also generate an auditory signal, though very muffled sound at best. While this is not an intentional feature, it is an additional means to provide information feedback that can be used.

To recap, the design choices made for the device were: a piezoelectric actuator is to be used as a single-point contact display to produce multiple vibrotactile signals, in order to simulate texture. Since texture is processed in parallel, the device can be expanded to multiple fingers for an additional perceptive gain when sensing the images. The only thing that remains is how to “read” the visual images. This implies that either the image has to be converted into a computer file (such as a binary file or bitmap), and the computer file read, or some type of photosensor must be used. The first method does require the image to be on the computer, and at some point beyond my project, may be the way the image is read. The second option can read images printed or those on a computer screen; however, the first option requires an additional light source in most cases. The primary issue is how to transform a visual image into different textures—this will effect what sensor is chosen. The most intuitive way to do this is to detect different colors in the image and use these colors to encode different textures. Using a color sensor, the device can be made so that as it moves across an image, it will sense the different colors that are in the image, giving a different vibrotactile feedback for each color. Once it decided that a color sensor was appropriate, the next issue was picking the right one. The sensor needed to have a small photo-receptive field size (the area of the sensor that detects the light reflected or emitted from the image), be sensitive to the entire range of visible light, have a quick response time, and not cost a great deal. A small photo-receptive field size keeps the spatial resolution for the device small; ideally, the spatial resolution for the device should be around that of the tactile system, or 1 to 2 mm. By having the sensor sensitive to the entire range of visible light, then it can detect all colors. The response time for the sensor is the time between the change in light (or color in our case) and the corresponding change in output voltage or current. The response time should be as fast as possible, as it adds time delay into the device. Too much time delay will hinder and distort the perception of the image, making the device ineffective. Cost per sensor should also be minimal to keep the overall cost of the device down. Ultimately, a Red-Green-Blue photodiode from Hamamatsu was chosen—it's sensitive to the entire range of visible light, with peak sensitivities to red, green, and blue lights, it costs $5 per sensor—a relatively low cost considering sensors range from around $2 to over $20 per sensor. It also has an excellent response time of around a few microseconds. It has a fairly small photo-receptive field size, but this was even further improved upon by adding a pin-hole camera-type lens to restrict the light that lands on the sensor to around a 2 mm circle. Further restriction does not allow enough light in to activate the sensor.

Using the design considerations developed from the analysis of the haptic system, 14 vibrotactile outputs (or simulated textures) were chosen to render 14 different colors. This is a larger set than that which will ultimately be used, but it represents a good base point to start developing the most effective set of textures possible. Twelve of these outputs were made from three “base” frequencies: a low (45 Hz), a medium (75 Hz), and a high (145 Hz), and four waveform types: a sine wave, a sawtooth wave, a square wave, and a modulated wave using a 15 Hz modulating frequency. Two additional textures were chosen to server as background or border patterns: one is a null texture (no output) and the other is a very high frequency (400 Hz) sine wave. These represent 14 colors, chosen based on the ease of their perception by individuals with low vision. They are: red, green, blue, yellow, purple, aquamarine, dark red, dark green, dark blue, dark yellow, dark purple, dark aquamarine, white, and black. These colors represent the greatest range of color variance; however, some colors obviously have low contrast and should not be used together (green/aquamarine or dark blue/black would be bad combinations).

The last design choices were to have the device worn on the finger: this allows both natural haptic exploration (with the hand) and eases the expansion to multiple fingers. Also, the device was made so that it would “turn on” when pressed against a surface by using a push-button switch that sits beside the photosensor on the underside of the device casing. This keeps the device simple and easier to use, as the user does have to search for an on-off switch and won't be prone to accidently leave it on, causing the batteries to drain unnecessarily. To use the device, they simply put it on and start exploring. The biggest issue will be allowing the users enough time practicing with the device, so they can better distinguish the different texture feedbacks.

Some primarily testing has been performed, namely in testing the spatial resolution of the device, the time delay for it, and testing of the perception of the set of textures chosen. In the worse case scenarios, the device could distinguish a line 2 mm thick and can distinguish between 2 lines spaced at least 2 mm apart, which lies within the desired range of human resolution. The best resolution is for the non-dark colors against a black background, for which lines 1.2 mm thick could be detected, and the device could distinguish between 2 lines spaced 1.5 mm apart.

Some issues exist with the temporal resolution that hasn't been exactly worked yet. To test the concept of the device, the parts of color determination and output control were done in a computer program that introduced a varying amount of time delay. The delay was reduced down to about 10 ms, but it decreased the fidelity in correctly outputting the vibrotactile signal. (Think of using low fidelity speakers and how they can distort sound.) I don't know how much of an issue this is, because the end device will run completely in hardware and will not be dependent on a computer for control.

The testing of the texture set on 6 subjects showed that it held some promise, but some of the conclusions based on the research might be inaccurate. Specifically, the conclusion that waveform shapes like square wave, triangle wave, and sawtooth wave are highly distinguishable seems mistaken from my test. The results did show that typically people were good at determining whether the base frequency was low, medium, or high, but had some confusion guessing the waveform shape. Below is the confusion matrix: the columns correspond to correct answers and the rows correspond to the guessed responses. The red columns correspond to the low frequencies, the green to the medium frequencies, and the blue to the high frequencies. Numbers 1-3 correspond to sine wave signals, 4-6 to sawtooth waves, 7-9 to square waves, and 10-13 to modulated waves. Numbers 0 and 13 correspond to the null output and the very high frequency output, which no subject confused for another signal. Overall, there was only about a 50% accuracy; however, subjects were given only a 20 minute training period prior to testing.

While the invention has been described in terms of its preferred embodiments, the invention can be practiced with modification within the spirit and scope of the appended claims.

1. A device for providing a user with a sense of an image presented on a display or paper medium, comprising:
at least one support;
at least one optical sensor positioned on each support that is attached to or carried by a user's hand or hands;
at least one actuator positioned on each support for providing a mechanical stimulus to an area of said user's hand or hands at a point or points that correspond to a location of color within said image or location of contrast in said image, whereby said user is provided with kinesthetically concordant tactile feedback.

2. The device of claim 1 wherein said image is two dimensional and said location of contrast is an edge or line of said image.

3. The device of claim 1 wherein said image is a two dimensional and said location of color within said imager reflects one or more of a specific color, a color hue, and a color saturation.

4. The device of claim 1 wherein said support is configured for attachment to a user's finger.

5. The device of claim 1 wherein there are a plurality of supports each of which is configured for attachment to a user's finger.

6. The device of claim 1 wherein said support is configured for attachment to a user's palm.

7. The device of claim 1 wherein said support is a stylus, and said actuator provides mechanical stimulus at a housing of said stylus held by said user's hand.

8. The device of claim 1 further comprising a contact sensor for sensing contact of said device with said display or paper medium.

9. The device of claim 1 further comprising a means for adjusting an optical detection sensitivity of said optical sensor.
